(19) United States
(12) Patent Application Publication
(10) Pub. No.: US 2008/0065257 A1
(43) Pub. Date: Mar. 13, 2008

(54) Controlled material removal rate (CMRR) and self-tuning force control in robotic machining process

(76) Inventors: Jianmin He, Wethersfield, CT (US); Hui Zhang, West Hartford, CT (US); Zengxi Pan, Hurstville (AU)

Correspondence Address: ABB Inc.;Legal Dept. - 4U6, 29801 Euclid Avenue, Wickliffe, OH, 44092-1832, US

(21) Appl. No.: 11/520,240

(22) Filed: Sep. 13, 2006

(51) Int. Cl. G06F 19/00

(52) U.S. Cl. 700/175; 700/173; 700/41

(57) ABSTRACT

A method and apparatus for a robotic machining process that gives a controlled removal rate of material from a workpiece when an object, tool or workpiece, held by a robot is brought into contact with a stationary object, workpiece or tool. A signal indicative of the force applied by the held object t the stationary object is used to control the rate at which the robot moves the held object in relation to the stationary object. Associated with the robot is a controller that has tunable proportional and integral gains. The controller determines a command for the feed rate of the tool when the tool engages the workpiece. In response to that command, the proportional and integral gains are tuned to obtain a cutting force to be applied to the workpiece when the tool engages the workpiece that is substantially the same as a desired cutting force.

### FIELD OF THE INVENTION

This invention relates to robots and more particularly to automatic control of a robotic machining process.

### DESCRIPTION OF THE PRIOR ART

Industrial robots are used to perform machining tasks because of their programmability, adaptability, flexibility, and their relatively low cost. As is described in U.S. patent application Ser. No. 11/220,174 filed on Sep. 6, 2005 and entitled “Robotic Machining With A Flexible Manipulator” (“the '174 application”), the disclosure of which is hereby incorporated herein by reference, the lower stiffness of industrial robots presents a disadvantage for a robotic machining process as compared to CNC machines. Thus, advanced control technologies were developed in order to meet the challenges of using industrial robots to perform machining tasks. One example of such an advanced control technology is described in the '174 application.

Machining processes, such as grinding, deburring, polishing, turning, and milling, which are generally speaking a material cutting process, are basically accomplished by applying process-specific tools to workpieces with a certain amount of force. A robotic machining process refers to the machining process that uses robots to remove undesired material from the workpiece.

Machining production requires that the time to produce parts must be minimized to increase productivity. The productivity of the machine is affected by the time needed for the machine to complete the process and any interruptions that occur during the machining process. Therefore, improving the rate at which material is removed and minimizing process interruptions due to premature tool wear or failure can decrease the machining time. Material removal rate (MRR) is a measurement of how fast material is removed from a workpiece, and it can be calculated by multiplying the cross-sectional area (width-of-cut times depth-of-cut) of the removed material by the linear feed speed of the tool.

Conventionally, the linear feed speed of the tool is fixed in spite of the variation of depth-of-cut and width-of-cut during the foundry part pre-machining process. Since most foundry parts have irregular shapes and uneven depth-of-cut, this will introduce a dramatic change of MRR, which results in a very conservative selection of machining parameters to avoid tool breakage, spindle overload and robot vibration. The concept of MRR control is to dynamically adjust the feed speed to keep MRR constant during the entire machining process. As a result, a much faster feed speed, instead of a conservative feed speed based on maximal depth of cut and width of cut position, could be adopted.

Usually there is no direct measurement of MRR. The cutting force of the machining process, which is also a function of the depth of cut, width of cut and feed speed, can be used as an indication of MRR. Thus, a CMRR can be achieved by regulating the machining force, which is much easier to measure than the MRR. Regulating the cutting force at a constant level during the machining process has many other benefits besides increasing MRR, such as, avoiding tool breakage, regulating robot and tool deflection, and prolonging tool life.

The objective of a CMRR is to assist the operator and programmer in the optimization of material removal to obtain the highest productivity possible during the “roughing” and “semi roughing” processes. Also, the tool breakage and spindle motor overload can be avoided by monitoring and controlling the process forces.

The cutting force in a machining process is usually controlled by adjusting the linear feed speed of the tool. But the relationship between process force and feed speed is usually nonlinear, and the process parameters, which describe the nonlinear relationship, are also constantly changing due to the variations of the cutting conditions, such as, depth and/or width of cut, spindle speed, tool wearing condition. Because of the foregoing reason, fixed-gain controllers have difficulties in maintaining consistent system performance and stability for a wide range of cutting conditions. Most of the time, conservative gains have to be chosen to keep the closed-loop system stable by trading off some of the control performances. During the last two decades, many adaptive and robust control techniques were developed in order to deal with the problems of fixed-gain controllers, but very few of them have been commercialized into products due to the complexity of the controller and the process.

The Model Reference Adaptive Control (MRAC) design technique of Landau and Lozano for a linear Single Input Single Output (SISO) model described by L. K. Daneshmend and H. A. Pak, “Model reference adaptive control of feed force in turning,” in ASME Journal of Dynamic systems, Measurement, and Control, vol. 108, September 1986, pp. 215-222 was used for the force regulation in a turning process. The process force model was assumed to be a first-order linear system for the control algorithm design.

Another MRAC design technique with indirect identification was proposed by R. G. Landers and A G. Ulsoy, “Model-based machining force control,” in ASME Journal of Dynamic Systems, Measurement, and Control, vol. 122, no. 3, 2000, pp. 521-527 (“Landers et al.”). In this approach, the nonlinear process force model is linearized by changing the variable technique, so the linear control technique could be employed for the nonlinear system.

A robust machining force control technique with process compensation was developed using Quantitative Feedback Theory (QFT) concepts as described by S. I. Kim, R. G. Landers, and A. G. Ulsoy, “Robust machining force control with process compensation,” in ASME Journal of Manufacturing Science and Engineering, vol. 125, August 2003, pp. 423-430. The robust control of this technique is easy to implement, but it does not guarantee consistent control performance, as compared to adaptive control. To successfully use this technique the process parameter changes, that is the depth of the cut, need to be known in advance to maintain tight performance bounds, which is not easy to achieve or not cost effectively achieved for many machining applications.

A self-tuning PI control algorithm was proposed for a lathe cutting process as described by M. Tomizuka and S. Zhang, “Modeling and conventional/adaptive PI control of a lathe cutting process,” in ASME Journal of Dynamic Systems, Measurement, and Control, vol. 110, December 1988, pp. 350-354 (“Tomizuka et al.”). The process force model in this proposed algorithm is assumed to be linear, and the adaptation is only for the open loop gain.

A nonlinear deadbeat controller was proposed by M. A. Elbestawi, Y. Mohamed, and L. Liu, “Application of some parameter adaptive control algorithms in machining,” in ASME Journal of Dynamic systems, Measurement, and Control, vol. 112, December 1990, pp. 611-617. The nonlinear process force is broken into a linear system coupled with an algebraic third order equation. The final control is calculated from the algebraic equation just as in Landers et al.

The present invention includes a self-tuning adaptive PI force control algorithm for an industrial robot that is used in a machining process. In contrast to the prior art described above, the nonlinear process force model is linearized via a different scheme from that described in Landers et al. Further, both the PI controller gains and the linearization procedure for the nonlinear cutting force model are adjusted on-line via an explicit identification process, which is different from the self-tuning PI control described in Tomizuka et al.

The self-tuning PI control of the present invention has an outer adaptation loop to tune the controller gains of the standard PI control structure. This simple structure significantly helps the implementation and maintaining of the control system, which is ideal for industrial applications. Both simulation and experimental results show that the self-tuning PI control of the present invention maintains the desired system performance, which is that the actual cutting force should always follow the desired cutting force, and stability for a wide range of cutting conditions.

### SUMMARY OF THE INVENTION

A system for a controlled removal rate of material from a workpiece by a tool in a robotic machining process, either the tool movable and the workpiece stationary or the workpiece movable and the tool stationary. The system comprises:

a controller for determining a command for the feed rate of either the movable tool or the movable workpiece when the tool engages the workpiece, the controller having tunable gains for both proportional and integral control; and

means responsive to the feed rate command and a cutting force to be applied to the workpiece when the tool engages the workpiece for tuning the proportional control and the integral control tunable gains to provide a command to control the cutting force to be applied to the workpiece when the tool engages the workpiece to be substantially the same as a desired cutting force.

A computer program product for controlling a robot so that a tool having a tip can perform a controlled removal rate of material from a workpiece when the tool engages the workpiece, either the tool movable and the workpiece stationary or the workpiece movable and the tool stationary, the robot having associated therewith a controller having tunable gains for proportional and integral control. The computer program product comprises:

a computer-readable medium having instructions for causing a computer to execute a method comprising:

determining a command for the feed rate of either the movable tool or the movable workpiece when the tool engages the workpiece; and

tuning the proportional control and the integral control tunable gains in response to the feed rate command and a cutting force to be applied to the workpiece when the tool engages the workpiece to provide a command to control the cutting force to be applied to the workpiece when the tool engages the workpiece to be substantially the same as a desired cutting force.

A system for controlling a robot so that a tool having a tip can perform a controlled removal rate of material from a workpiece when the tool engages the workpiece, either the tool movable and the workpiece stationary or the workpiece movable and the tool stationary, the robot having associated therewith a controller having tunable gains for proportional and integral control. The system comprises:

a computing device having therein program code usable by the computing device, the program code comprising:

code configured to determine a command for the feed rate of either the movable tool or the movable workpiece when the tool engages the workpiece; and

code configured to tune the proportional control and the integral control tunable gains in response to the feed rate command and a cutting force to be applied to the workpiece when the tool engages the workpiece to provide a command to control the cutting force to be applied to the workpiece when the tool engages the workpiece to be substantially the same as a desired cutting force.

In a system for controlling the movement of a robot using a controller having tunable gains for proportional and integral control a method for obtaining a controlled removal rate of material from a workpiece when a tool engages the workpiece, either the tool movable and the workpiece stationary or the workpiece movable and the tool stationary. The method comprises:

adding a loop to the controller to tune the proportional control and the integral control tunable gains in response to a command for the feed rate of either the movable tool or the movable workpiece when the tool engages the workpiece and a cutting force to be applied to the workpiece when the tool engages the workpiece to provide a command to control the cutting force to be applied to the workpiece when the tool engages the workpiece to be substantially the same as a desired cutting force.

A system for a controlled removal rate of material from a workpiece by a tool in a robotic machining process, either the tool movable and the workpiece stationary or the workpiece movable and the tool stationary. The system comprises:

a robot; and

a controller having tunable gains for both proportional and integral control, the controller responsive to a command for the feed rate of the movable tool or the movable when the tool engages the workpiece and a cutting force to be applied to the workpiece when the tool engages the workpiece for tuning the proportional control and the integral control tunable gains to provide a command to control the robot so that the cutting force to be applied to the workpiece when the tool engages the workpiece to be substantially the same as a desired cutting force.

A method for regulating within a predetermined range the force an object held by a robot applies to a stationary object when said held object is brought into contact with said stationary object. The method comprises:

obtaining a signal indicative of said force applied by said held object to said stationary object; and

using said force applied indicative signal to control the rate at which said robot moves said held object in relation to said stationary object when said held object is brought into contact with said stationary object.

A computer program product for regulating within a predetermined range the force an object held by a robot applies to a stationary object when said held object is brought into contact with said stationary object. The computer program product comprises:

a computer-readable medium having instructions for causing a computer to execute a method comprising:

obtaining a signal indicative of said force applied by said held object to said stationary object; and

using said force applied indicative signal to control the rate at which said robot moves said held object in relation to said stationary object when said held object is brought into contact with said stationary object.

A system for regulating within a predetermined range the force an object held by a robot applies to a stationary object when said held object is brought into contact with said stationary object. The system comprises:

a computing device having therein program code usable by said computing device, the program code comprising:

code configured to obtain a signal indicative of said force applied by said held object to said stationary object; and

code configured to use said force applied indicative signal to control the rate at which said robot moves said held object in relation to said stationary object when said held object is brought into contact with said stationary object.

### DESCRIPTION OF THE DRAWING

FIG. 1a shows a robotic machining setup with a moving tool, stationary workpiece and force sensor measurement.

FIG. 1b shows a robotic machining setup with a moving tool, stationary workpiece and spindle motor current measurement.

FIG. 1c shows a robotic machining setup a with stationary tool, moving workpiece and force sensor measurement.

FIG. 1d shows a robotic machining setup with a stationary tool, moving workpiece and spindle motor current measurement.

FIG. 2 shows a milling process using an industrial robot.

FIG. 3 shows the root locus for the robot dynamic model.

FIG. 4 shows the design of the self tuning PI controller of the present invention.

FIG. 5 shows a block diagram of a robotic machining system with a self-tuning PI controller.

FIG. 6 shows the simulation results of a fixed gain PI controller without an anti-windup scheme for a step change in cutting depth.

FIG. 7 shows the simulation results for a step change in cutting depth for a self-tuning PI controller that has only open-loop gain adaptation, and does not have adaptation for linearization procedure.

FIG. 8 shows the simulation results for the self-tuning PI control of the present invention for a step change in cutting depth.

FIG. 9 shows by way of simulation the adaptation of the self tuning PI control of the present invention to a continuous change in cutting depth.

FIG. 10 shows the change in cutting depth of a workpiece in an experimental setup wherein the self tuning PI controller of the present invention is compared to a fixed gain PI controller.

FIG. 11 shows the experimental results for the fixed gain PI controller.

FIG. 12 shows the experimental results for the self tuning PI controller of the present invention.

FIG. 13 shows a block diagram for a system that may be used to implement the self tuning controller of the present invention.

### DETAILED DESCRIPTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Furthermore, the present invention may take the form of a computer program product on a computer-usable or computer-readable medium having computer-usable program code embodied in the medium. The computer-usable or computer-readable medium may be any medium that can contain, store, communicate, propagate, or transport the program for use by or in connection with the instruction execution system, apparatus, or device and may by way of example but without limitation, be an electronic, magnetic, optical, electromagnetic, infrared, or semiconductor system, apparatus, device, or propagation medium or even be paper or other suitable medium upon which the program is printed. More specific examples (a non-exhaustive list) of the computer-readable medium would include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device.

Computer program code for carrying out operations of the present invention may be written in an object oriented programming language such as Java, Smalltalk, C++ or the like, or may also be written in conventional procedural programming languages, such as the “C” programming language. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Two different setups for robotic machining are available: a stationary tool and a moving tool, where tool refers to the cutting tool driven by a spindle. A stationary tool means that the robot holds the workpiece and moves the workpiece along the programmed path around the stationary cutting tool. A moving tool means the robot holds the cutting tool and moves the tool along the programmed path around the stationary workpiece.

One of two kinds of sensory information either spindle motor current or force sensor measurement, can be used to provide a feedback signal indicative of the cutting force. In both cases, certain pre-processing has to be performed to distinguish signal variation caused by factors other than the cutting load.

When using spindle motor current as feedback, the measurement is the voltage value that is proportional to the spindle motor current. Most commercial spindle drivers have a current monitor output terminal. This signal has to be regulated to the same range of the robot controller A/D card input. The motor current reading when the spindle is turning at the same RPM as during the real machining condition without actual cutting should be recorded as an offset. The measured signal is re-scaled to the cutting force range and then sent to a robot controller.

When a force sensor is used to provide the feedback signal, the force sensor signal is preprocessed to include filtering and gravity compensation. Low pass filtering is used to remove the noise from the signal. The gravity compensation is used to remove the static payload of the cutting tool, spindle or workpiece at any robot configuration. The mass and center of gravity of the payload is first calibrated. During the cutting process, the actual payload at a certain robot pose, that is position and orientation, is subtracted from the sensor reading to obtain the real cutting forces. In CMRR, only the magnitude of the force vector is used for feedback, while the entire force information is useful for other purposes.

The advantage of using a force sensor to provide a feedback signal is that it is easier to set a reference for the force sensor feedback signal than for the spindle motor current since that current must be calibrated to indicate the machining force and thus the force sensor signal is more meaningful to the robot operator than the motor current. The advantage of using a spindle motor current to provide a feedback signal is that it is low cost and less noisy. Still the most important factor that decides which sensory signal to use is the sensitivity of the sensory signal to the variations of cutting parameters.

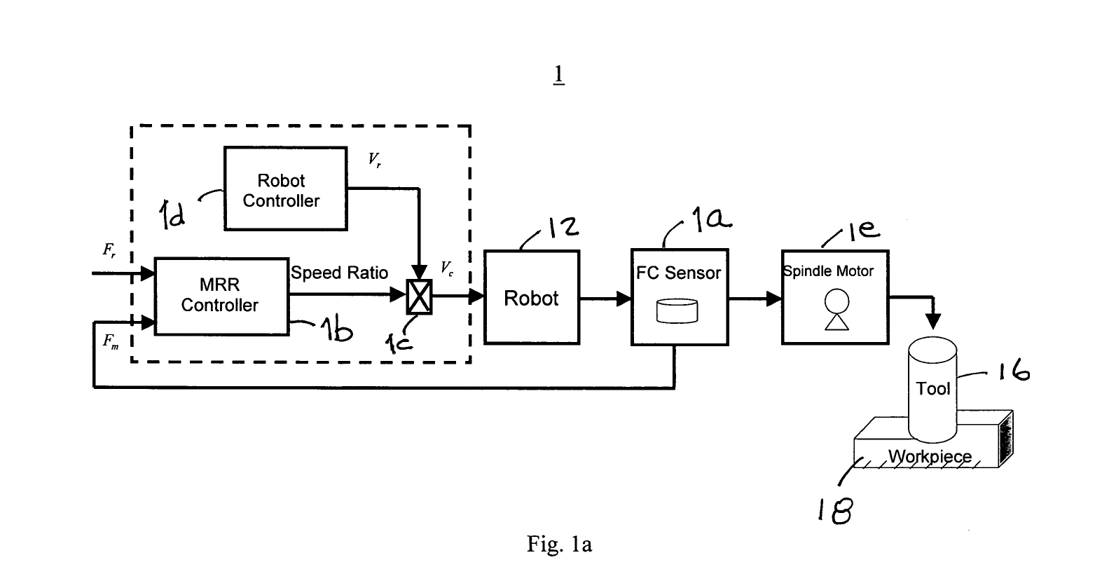

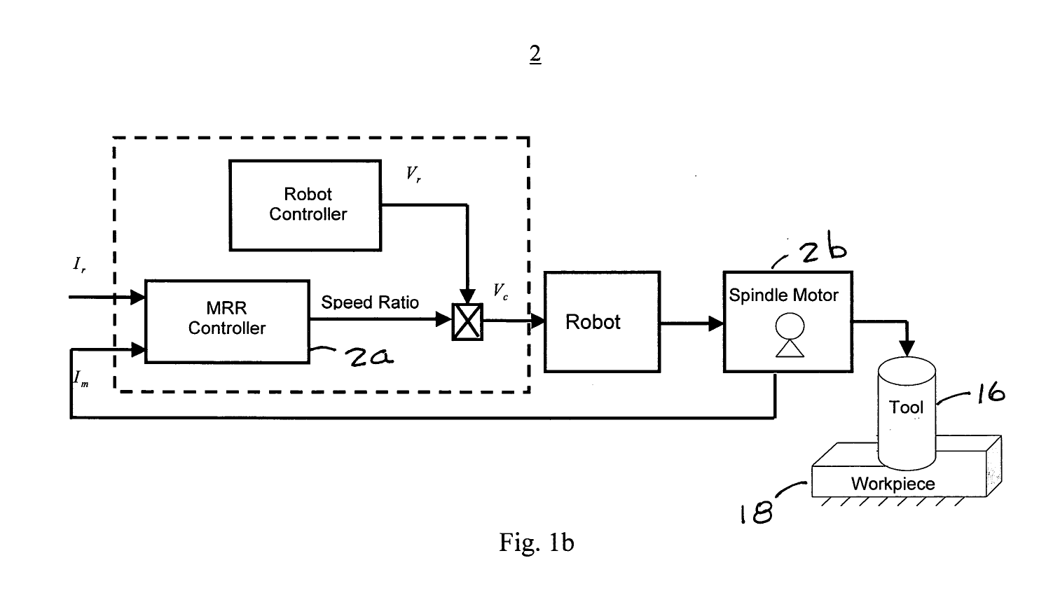

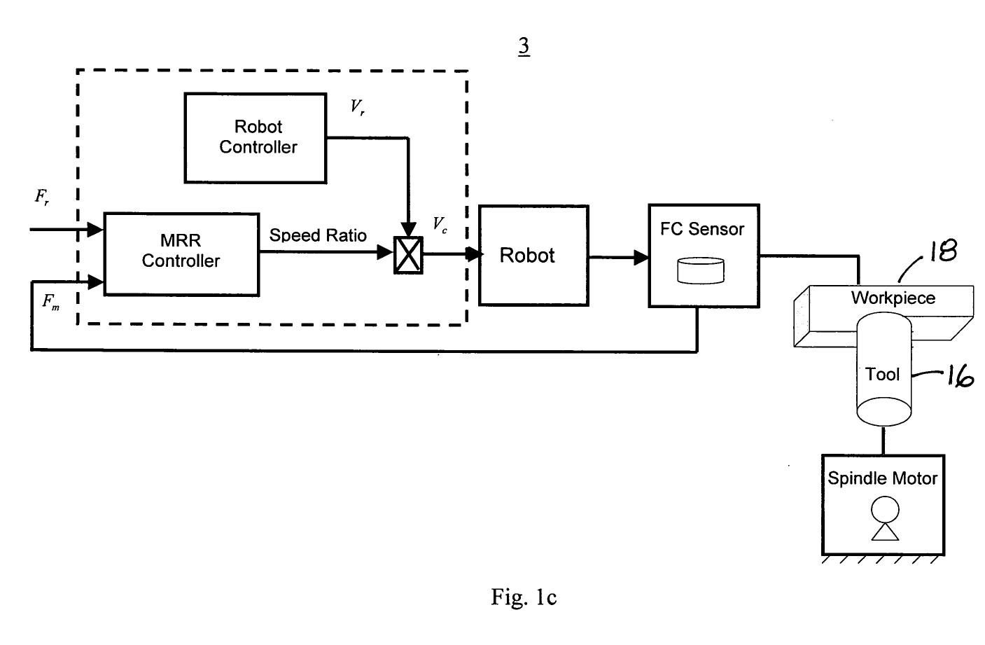

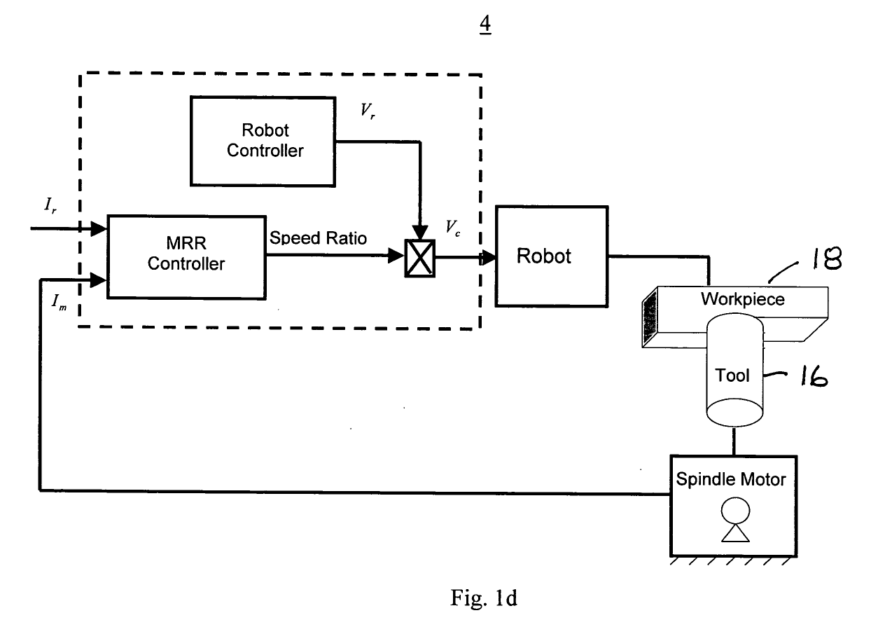

FIGS. 1a, 1b, 1c, and 1d show different robotic machining setups 1. FIG. 1a shows the setup 1 with a moving tool 16, stationary workpiece 18 and a force sensor 1a that provides the feedback signal indicative of the cutting force to a MRR controller 1b which provides a signal indicative of the speed ratio to a multiplier 1c the other input of which is the velocity reference Vr from robot controller 1d. The output of multiplier 1c is the velocity command Vc to robot 12. Also shown in FIG. 1a is the spindle motor 1e.

FIG. 1b shows the setup 2 which is identical to the setup 1 of FIG. 1a in that the workpiece 18 is stationary and the tool 16 is moving except that setup 2 does not include force sensor 1a and thus the feedback signal indicative of cutting force at one input to MRR Controller 2a is from the spindle motor 2b. FIGS. 1c and 1d show setups 3 and 4, respectively which are identical to setups 1 and 2, respectively except that in setups 3 and 4 it is the tool 16 that is stationary the workpiece 18 that is moving.

Thus the CMRR implementation is similar for all the setups 1-4, whether the feedback is from a spindle motor current or a force sensor measurement. Hereafter, the detailed explanation will only focus on the setup 1 of FIG. 1a that has a moving tool 16, stationary workpiece 18 and force sensor measurement.

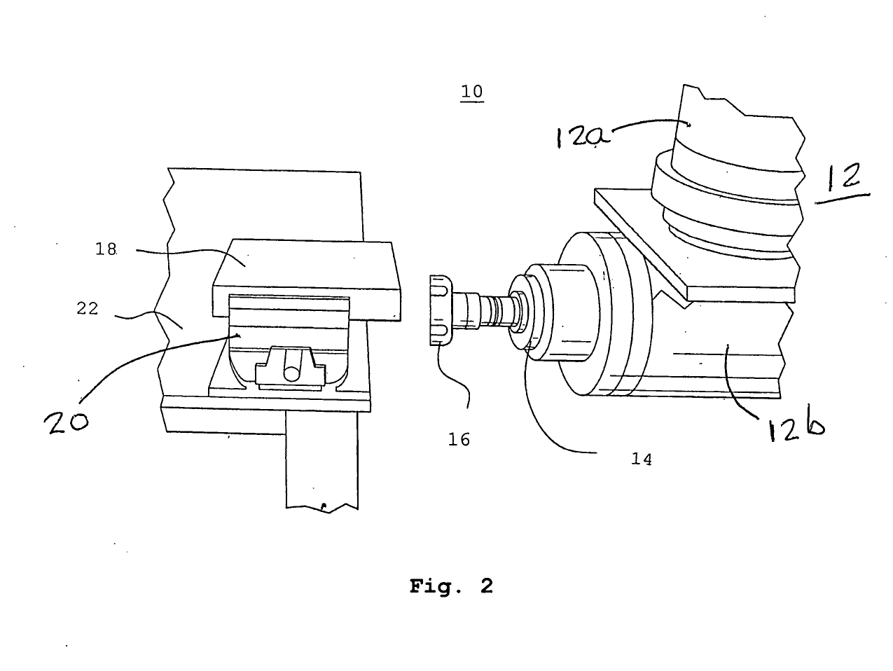

A robotic milling process 10 using an industrial robot 12 is shown in FIG. 2. Only part of robot 12 is shown in FIG. 2. More particularly, FIG. 2 shows a portion of the upper arm 12a and the wrist 12b on one end of the upper arm 12a of robot 12. A spindle 14 is fixed in the wrist 12b with a cutter 16 mounted therein. The work piece 18 to be machined by cutter 16 is held by a fixture 20 which is fixedly attached to a work table 22. The industrial robot 12 may, for example, be the model IRB 6400 robot which is manufactured and sold by ABB.

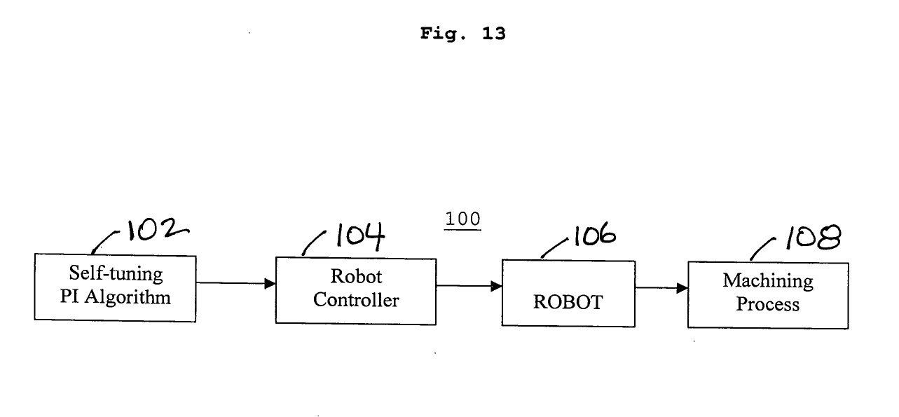

The cutting force of cutter 16 is regulated by adjusting the tool feedrate in the milling process. Since the cutting tool 16 is mounted on the tip of robot end effector (the combination of the cutting tool 16 and the mechanism in the robot 10 to grasp tool 16) the tool feedrate is controlled by commanding the robot end effector speed. As is well known to those of ordinary skill in this art, the commands are provided by a robot controller which is not shown in FIG. 2 but is shown in FIG. 13.

The robot model for the machining process is the dynamic from the command feedrate to the actual tool feedrate. A time-invariant linear model should be accurate enough to model the robot dynamic, where the robot end effector only moves in a small range of the workspace, which is true for most robotic machining applications. The experimentally identified dynamic model of the ABB IRB 6400 robot is

$$\frac{f ( s )}{{f}_{c} ( s )} = \frac{63 {s}^{2} - 45800 s + 4330000}{{s}^{3} + 575 {s}^{2} + 98670 s + 4313000} \qquad ( 1 )$$

where f(s) is the actual tool feedrate and f_{c}(s) is the feedrate command.

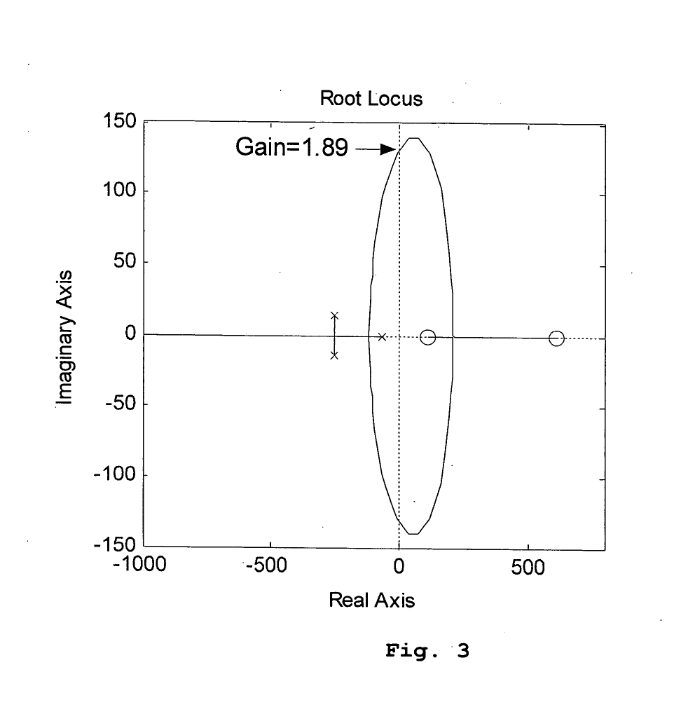

The dynamic model is a stable non-minimum phase system, and its root locus is shown in FIG. 3. FIG. 3 shows that the closed loop system becomes unstable when the open loop gain is greater than 1.89. Therefore to maintain the closed-loop system stability during the changing process it is important to adjust controller gains to compensate process parameter changes during a robotic machining process.

The relationship between the machining process force and the tool feedrate is nonlinear and time-varying, as shown in the following static model described in Landers et al.:

F=Kd^{α}f^{β} (2)

where K is the gain of the cutting process; d is the cutting depth; f is the tool feedrate; α and β are coefficients, and their values are usually between 0 and 1.

The depth of cut, d, depends on the geometry of the workpiece surface. That geometry usually changes during the machining process, and is difficult to measure accurately on-line. The cutting depth is the major contributor that causes the process parameter change during the machining process. K, α, and β depend on those cutting conditions, such as, spindle speed, tool and workpiece material, and tool wearing condition, which are substantially stable during the cutting process. If the tool and/or the workpiece is changed, these parameters could change dramatically. But they do not change as quickly as the depth of cut d does during the machining process as explained above.

A force model valid only for the specific tool and workpiece used in a laboratory setup, which may be as shown in FIG. 2, wherein the tool is a general cutting tool and the workpiece is 6063 aluminum block, of the present invention is identified from experiment as:

F=23d^{0.9}f^{0.5} (3)

### Equation (3) models the process force very well in the lab, and it is also used as a nominal force model for the simulations described below.

The tool feedrate f is chosen as the control variable, i.e., the process force is controlled by adjusting the feedrate. The static process force model contributes only to the open loop gain of the whole robotic machining process, if the nonlinearity of equation (2) is not considered. Since the cutting depth in equation (2) is constantly changing during the process, the open loop gain also changes constantly. The fixed-gain PI control is not able to maintain the consistent system performance and even stability in extreme cases.

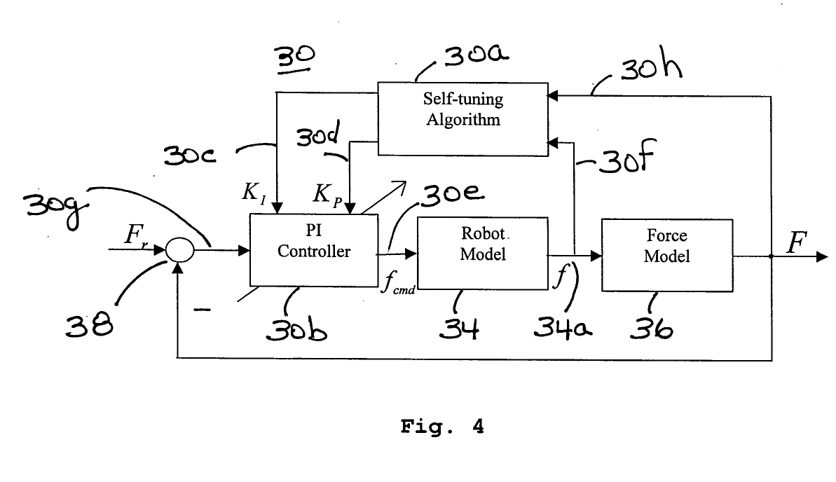

The design of the self-tuning PI controller 30 of the present invention is shown in FIG. 4 as two blocks 30a and 30b. Block 30a is labeled “Self-tuning algorithm” and block 30b is labeled “PI Controller”. As is described in more detail below, the self-tuning algorithm of block 30a is shown in equations 11 and 12 herein and that algorithm calculates the integral gain K_{I} and the proportional gain K_{P} of block 30b to thereby allow the PI controller 30 to change those gains on-line.

Block 30a has two outputs. One output is the integral gain K_{I} 30c and the other output is the proportional gain K_{P} 30d each of which are inputs to PI Controller block 30b. The output of the PI Controller block 30b is the tool feed rate command f_{cmd} 30e and is the input to block 34 which represents the robot system, that is, the robot arm plus the robot controller. The output of model 34 is the tool feed rate f 34a and is the input to block 36 which represents the machining process and the input 30f to the Self-tuning Algorithm block 30a. The force model 36 is responsive to the tool feed rate f to produce the cutting force F which is the input 30h to the Self-tuning Algorithm block 30a.

The difference between the cutting force reference Fᵣ and the cutting force F is obtained at summing point 38 to provide an input 30g to the PI controller block 30b. Thus, since the inputs to the Self-tuning Algorithm block 30a are the tool feed rate f and the cutting force F and the outputs of that block are the integral gain K_{I} and the proportional gain K_{P} inputs to the PI Controller block 30b, the PI controller 30 of the present invention changes those gains on-line.

The PI control in FIG. 4 is given as

$$C ( s ) = {K}_{P} + \frac{{K}_{I}}{s} \qquad ( 4 )$$

where K_{P} and K_{I} are the proportional and integral gains respectively.

The nonlinear static cutting force model of equation (2) can, by lumping the effect of parameters K, d, and α to the process force into one parameter, k_{f}, be rewritten as:

F=Kd^{α}f^{β}=k_{f}f^{β} (5)

where k_{f}=Kd^{α}.

The force F′ is defined as follows:

F′=(F)^{1/β} (6)

Putting equation (6) together with equation (5) gives:

F′=(F)^{1/β}=(k_{f})^{1/β}f=kf (7)

where k=(k_{f})^{1/β} is time-varying.

Instead of controlling cutting force F, the present invention, for the nonlinear system described herein, controls F′ to follow the new command force, i.e., Fᵣ′=(Fᵣ)^{1/β}, which is equivalent to controlling F to follow the original reference force Fᵣ. By using equation (7), the nonlinear system described herein is exactly linearized, and this linear system design technique can be applied to design a PI control for the nonlinear system. As can be appreciated, the linearization method described above is not needed where the application is linear in which the present is to be used is a linear system.

The zero of the PI controller 30 is put at −66.5 to cancel the slow stable pole of the robotic dynamic model 34. Since the zero of the PI controller 30 is fixed, the proportional and integral gains obtained from the zero of the PI controller 30 are:

K_{P}=0.015α, K_{I}=α (8)

where α is chosen to make the open loop gain of the whole system at the desired value.

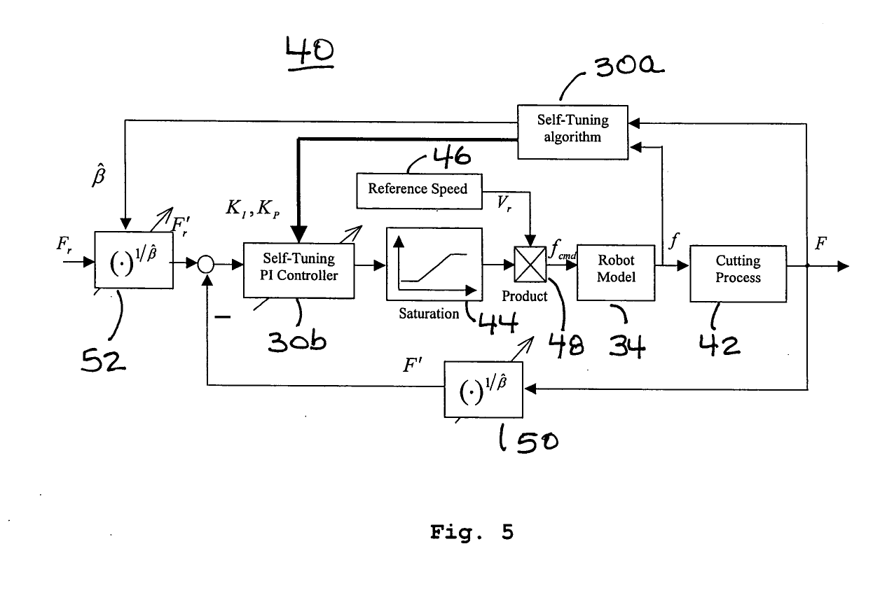

The robotic machining system 40 with a self-tuning PI controller 30 and robot model 34 of FIG. 4 is shown in FIG. 5. FIG. 5 shows the force model 36 of FIG. 4 in the form of a cutting process 42. FIG. 5 also shows block 44 representative of the saturation nonlinearity described below, block 46 which provides the reference speed Vᵣ, product block 48 which multiplies the speed reference Vᵣ and the output of the PI Controller 30b as modified by block 44 to provide the feed rate f_{cmd} as the input to robot model 34, and blocks 50 and 52 which provide F′ and Fᵣ′, respectively.

The cutting force is controlled by varying the robot end-effector speed in the tool feed direction. In actual implementation, the robot motion is planned in advance based on a pre-selected reference speed. The PI control generates the ratio signal to interpolate the reference trajectory in order to adjust the tool feedrate. Thus the achieved robot end-effector speed can not be greater than the pre-selected reference speed. There is also a positive lower limit (because negative feedrate is meaningless) assigned for the tool feedrate command to avoid a “stop and go” situation.

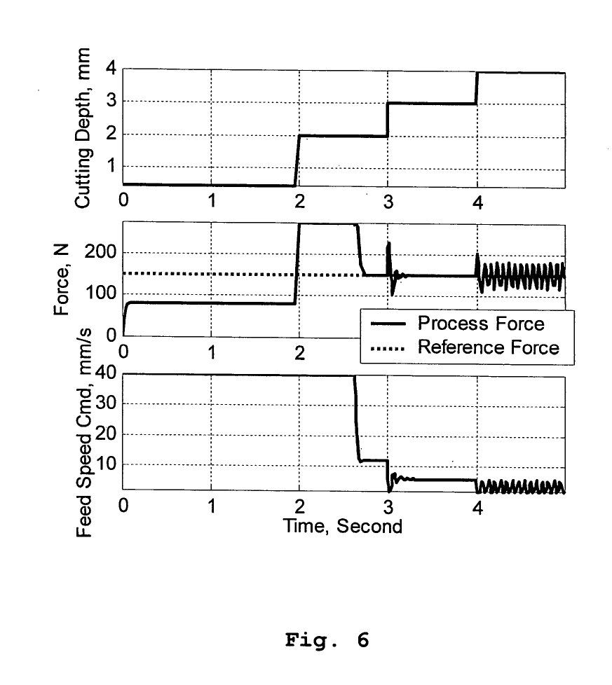

As shown in FIG. 5 by block 44, saturation nonlinearity is introduced into the robot machining system 40 by the control algorithm because the algorithm artificially limits the PI controller output between an upper and lower boundary. As is shown in FIG. 6, the saturation nonlinearity causes integration windup of the PI controller and thus a standard anti-windup scheme is necessary for the PI control to avoid the integration windup.

Let Vᵣ, in FIG. 5, be the maximum feedrate that the tool can be commanded. The saturation nonlinearity is defined as:

$$sat ( u ) = \{ \begin{matrix}1 & u \geq 1 \\ u & δ < u < 1 \\ δ & u \leq δ\end{matrix} \qquad ( 9 )$$

where δ≧0 and is set as described below to 0.05 for the simulation, and δVᵣ is the minimum feedrate command for the machining process.

From equations (1), (4), (7), and (8), and without considering the saturation nonlinearity, the open loop gain of the system 40 shown in FIG. 5 is calculated as:

α·Vᵣ·k=28.84 (10)

### With this open loop gain the closed loop system 40 has a dominant conjugate pair of poles with a damping factor around 0.7. This damping factor gives the closed loop system a quick response and very small overshoot.

Combining equations (10) and (8), the proportional and integral gains are:

$${K}_{I} = \frac{28.84}{{V}_{r} \hat{k}} , {K}_{P} = \frac{0.432}{{V}_{r} \hat{k}} \qquad ( 11 )$$

where \hat{k} is the on-line estimation of k in equation (7). Equation (11) is used as the self-tuning rules for the PI controller, which aims to maintain the open loop gain at 28.84.

The following standard recursive linear least square (RLS) method is used to identify k and β of equation (7)

$$k ( t ) = \frac{P ( t - 1 ) x ( t )}{λ + {x}^{T} ( t ) P ( t - 1 ) x ( t )} \\ \hat{θ} ( t ) = \hat{θ} ( t - 1 ) + k ( t ) [ y ( t ) - \hat{θ} ( t - 1 ) x ( t ) ] \\ P ( t ) = \frac{1}{λ} [ I - K ( t ) {x}^{T} ( t ) ] P ( t - 1 ) \qquad ( 12 )$$

where θ(t)=(ln\hat{k}(t)\hat{β}); y(t)=lnF(t) x(t)=(1 lnf(t))^{T}; t=1,2,3, . . . is the sampling point; λ is the forgetting factor, which is usually chosen between 0.95 and 0.99. The on-line identified \hat{k} and \hat{β} are used in equations (7) and (11) respectively as the adaptive rules.

Several simulation results are presented herein to show the effectiveness of the self-tuning PI control of the present invention in compensating the cutting condition changes. The control performance is compared between the self-tuning PI controller of the present invention and a fixed-gain PI controller, where the fixed-gain PI controller is designed ideally for the cutting depth of 2 mm.

In all of the simulation cases: the reference feedrate Vᵣ is chosen at 40 mm/s; the lower limit of saturation δ is 0.05, the forgetting factor λ of equation 12 is 0.95; and the reference force Fᵣ is 150N. The fixed-gain PI controller gains are calculated to be:

K_{I}=3.75×10⁻⁴, K_{P}=5.88×10⁻⁶

The fixed-gain PI controller result (without an anti-windup scheme) is shown in FIG. 6. The cutting depth in FIG. 6 changes in steps, from 0.5 mm to 4 mm. At 0.5 mm, the fixed-gain controller is saturated. When the cutting depth changes to 2 mm at 2 s, the controller takes almost is to fight the winded-up integration. When the cutting depth is 2 mm, the control performance is very good. But the control performance becomes worse at 3 mm, and becomes unstable at 4 mm because as shown in FIG. 6 the control starts to vibrate at 4 mm.

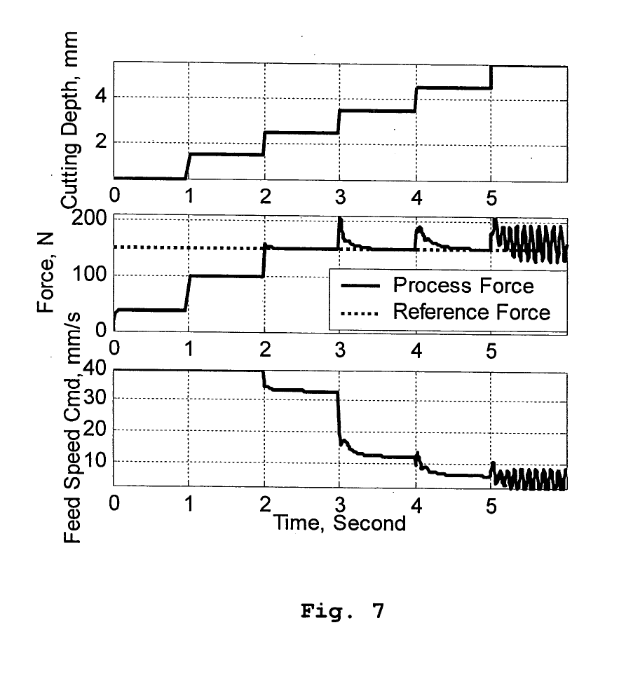

The purpose of the simulation case shown in FIG. 7 is to show that the adaptation of β is important. If only k is estimated in equation (10) and it is assumed that β is known in advance (but actually is incorrect compared to its real value), the control system could become unstable, since the exact linearization procedure in equation (11) will not be met. In FIG. 7, PI controller gains are tuned on-line based on the estimation of k. β is assumed to be 0.5, but actually is 0.3 in the process. As shown in FIG. 7, the control system starts to vibrate at the cutting depth of 5 mm.

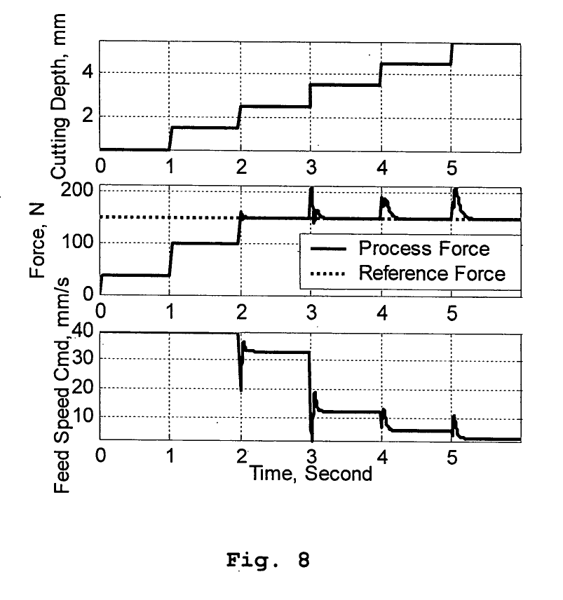

FIG. 8 shows the result of a simulation case for the self-tuning PI control of the present invention with both k and β adaptation (for β is not known accurately in advance). The self-tuning control system 40 of the present invention for this simulation case is stable and control performance is consistent for all the cutting conditions, compared to the simulation cases shown in FIG. 6 and FIG. 7. The self-tuning PI control is effective in compensating the process parameter changes during the machining process. The force is well regulated as shown in FIG. 8, even though the cutting condition changes during the process.

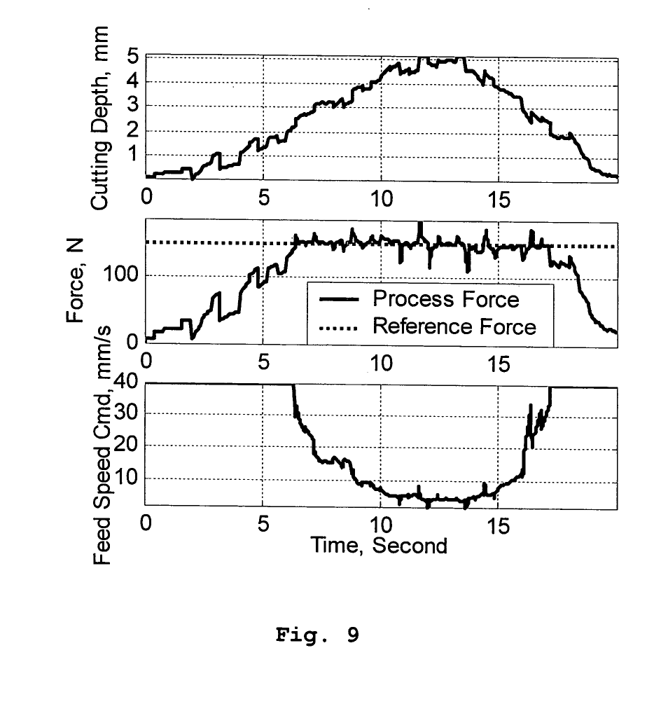

In a real machining process, the cutting depth may change continuously, which is different from the above described simulation cases, where the cutting depth changes in steps. As is shown in FIG. 9 via simulation, the adaptation of process parameter changes by the self-tuning control system is fast enough and can still maintain the system stability and good control performance.

Experimental studies were conducted for a face milling process to verify the stability and performance of the self-tuning PI control algorithm of the present invention. The robot used in the milling process is the ABB IRB 6400, the same robot used for the parameter identification described above. The robotic face milling process is shown in FIG. 2. The force measurements in the experiments were filtered with a low-pass filter before they were used as feedback.

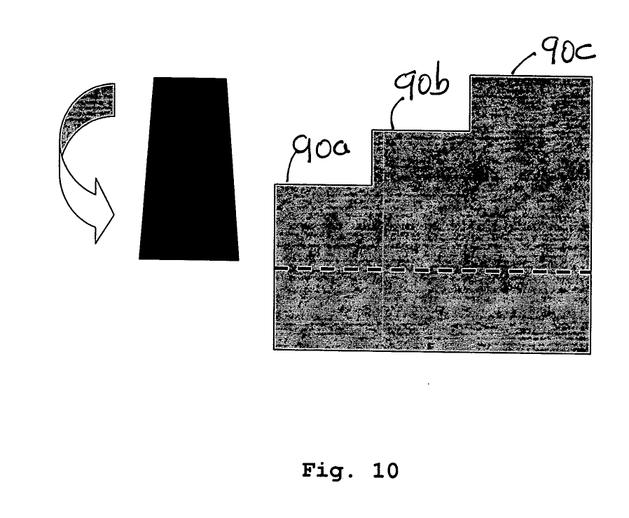

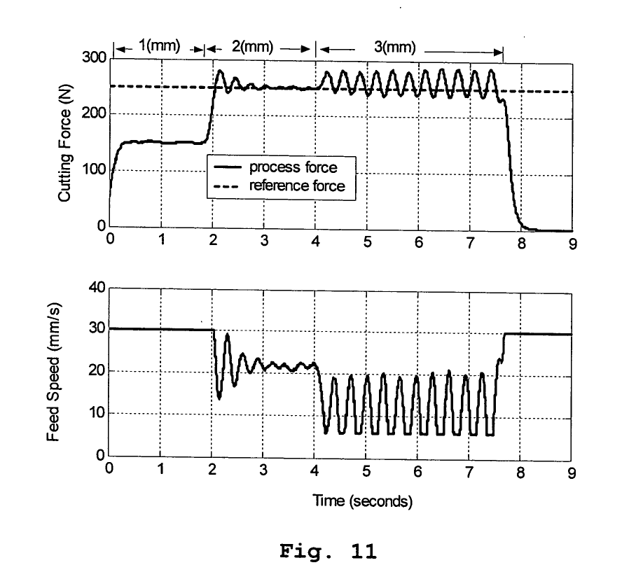

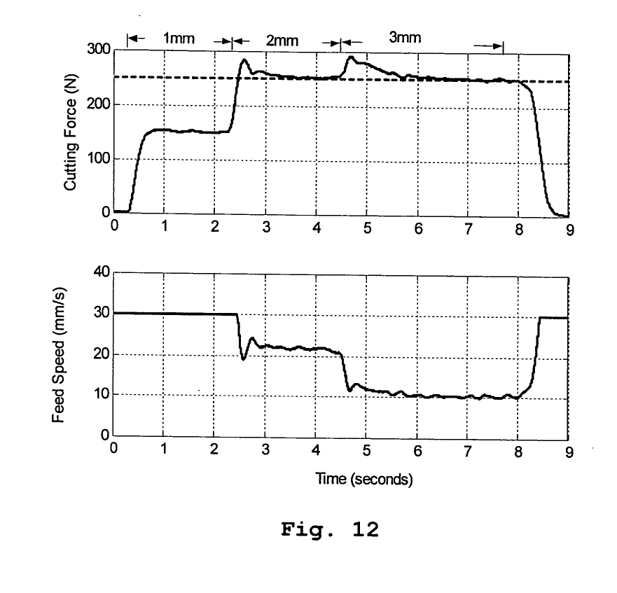

During the face milling experiment, a spindle 14 of FIG. 2 is held by the robot arm, and an aluminum block (AL2040) 18 of FIG. 2 is fixed on a steel table 22 of FIG. 2. As is shown in FIG. 10, the cutting depth of the process is changed with a step of 1 mm from 1 mm at 90a to 2 mm at 90b and to 3 mm at 90c. Both the fixed gain PI control algorithm and the self-tuning PI control algorithm of the present invention were tested with this experimental setup. The control system performance and stability are compared for these two controllers. The experimental results for the fixed-gain PI controller and for the self-tuning PI controller are shown in FIG. 11 and FIG. 12, respectively.

The reference force was set at 250N for the experiments. When the cutting depth is 1 mm at 90a, both controllers are saturated with a full command speed at 30 mm/s. When the cutting depth is changed to 2 mm at 90b, the fixed-gain PI controller starts, as is shown in FIG. 11, to vibrate, but is still stable. When the cutting depth is changed to 3 mm, the fixed-gain PI controller becomes, as is shown in FIG. 11, unstable, just as predicted in the simulation results. On the other hand, the self-tuning adaptive controller maintains stability and performance for all the cutting depths as shown in FIG. 12.

Referring now to FIG. 13, there is shown a system 100 which may be used to implement the self-tuning PI controller of the present invention described above. The system 100 includes the self-tuning PI Algorithm 102 described above resident, as described above, on a suitable media in a form that can be loaded into the robot controller 104 for execution. Alternatively, the algorithm can be loaded into the controller 104 or may be downloaded into the controller 104, as described above, by well known means from the same site where controller 104 is located or at another site that is remote from the site where controller 104 is located. As another alternative, the algorithm 102 may be resident in controller 104 or the algorithm 102 may installed or loaded into a computing device (not shown in FIG. 13) which is connected to controller 104 to send commands to the controller.

As can be appreciated by those of ordinary skill in the art, when the algorithm is in controller 104, the controller functions as a computing device to execute the algorithm 102. The controller 104 is connected to robot 106 which in turn is used to perform the machining process 108. Thus if the algorithm 102 is executed by controller 104 or if the controller 104 receives commands from a computing device that executes the algorithm 102 the robot 106 is controlled to perform the machining process 108 in accordance with the present invention. It should be appreciated that the adaptive PI control algorithm 102 can be implemented on the robot controller 104 as a software product, or implemented partly or entirely on a remote computer, which communicates with the robot controller 104 via a communication network, such as, but not limited to, the Internet.

It should be appreciated that the present invention changes the speed of a robot based on real-time machining process information in order to regulate the process force in a certain range, that is to give the desired CMRR. Thus the self tuning controller that has tunable proportional and integral gains described above is only one example of how that desirable result is accomplished.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A system for a controlled removal rate of material from a workpiece by a tool in a robotic machining process, either said tool movable and said workpiece stationary or said workpiece movable and said tool stationary, comprising:
a controller for determining a command for the feed rate of either said movable tool or said movable workpiece when said tool engages said workpiece, said controller having tunable gains for both proportional and integral control; and
means responsive to said feed rate command and a cutting force to be applied to said workpiece when said tool engages said workpiece for tuning said proportional control and said integral control tunable gains to provide a command to control said cutting force to be applied to said workpiece when said tool engages said workpiece to be substantially the same as a desired cutting force.

2. The system of claim 1 further comprising a robot, said robot holding said tool and responsive to said command to control said cutting force to move said tool along a predetermined path when said tool engages said workpiece.

3. The system of claim 1 further comprising a robot, said robot holding said workpiece and responsive to said command to control said cutting force to move said workpiece along a predetermined path when said tool engages said workpiece.

4. The system of claim 1 further comprising a force sensor for providing a signal to said controller indicative of a cutting force applied by said tool to said workpiece when said tool engages said workpiece, said controller also responsive to said applied cutting force for determining either said feed rate command for said tool when said tool is movable or said feed rate command for said workpiece when said workpiece is movable.

5. The system of claim 1 further comprising a robot, said robot holding either said tool or said workpiece and said workpiece is stationary when said robot holds said tool and said tool is stationary when said robot holds said workpiece, said robot responsive to said command to control said cutting force to either move said tool along a predetermined path when said robot holds said tool and said tool engages said stationary workpiece or move said workpiece along a predetermined path when said robot holds said workpiece and said workpiece engages said stationary tool.

6. The system of claim 5 further comprising a force sensor for providing a signal to said controller indicative of the cutting force applied by said tool said workpiece when said tool engages said workpiece, said controller also responsive to said applied cutting force for determining said tool feed rate command.

7. The system of claim 1 further comprising a robot, said robot comprising a spindle driven by a motor to drive either said tool when said robot holds said tool or said workpiece when said robot holds said workpiece and means for providing a signal related to spindle motor current indicative of the cutting force applied to said by said tool to said workpiece when said tool engages said workpiece, said controller also responsive to said applied cutting force for determining either said feed rate command for said tool when said tool is movable or said feed rate command for said workpiece when said workpiece is movable.

8. A computer program product for controlling a robot so that a tool having a tip can perform a controlled removal rate of material from a workpiece when said tool engages said workpiece, either said tool movable and said workpiece stationary or said workpiece movable and said tool stationary, said robot having associated therewith a controller having tunable gains for proportional and integral control, comprising:
a computer-readable medium having instructions for causing a computer to execute a method comprising:
determining a command for the feed rate of either said movable tool or said movable workpiece when said tool engages said workpiece; and
tuning said proportional control and said integral control tunable gains in response to said feed rate command and a cutting force to be applied to said workpiece when said tool engages said workpiece to provide a command to control said cutting force to be applied to said workpiece when said tool engages said workpiece to be substantially the same as a desired cutting force.

9. A system for controlling a robot so that a tool having a tip can perform a controlled removal rate of material from a workpiece when said tool engages said workpiece, either said tool movable and said workpiece stationary or said workpiece movable and said tool stationary, said robot having associated therewith a controller having tunable gains for proportional and integral control, comprising:
a computing device having therein program code usable by said computing device, said program code comprising:
code configured to determine a command for the feed rate of either said movable tool or said movable workpiece when said tool engages said workpiece; and
code configured to tune said proportional control and said integral control tunable gains in response to said feed rate command and a cutting force to be applied to said workpiece when said tool engages said workpiece to provide a command to control said cutting force to be applied to said workpiece when said tool engages said workpiece to be substantially the same as a desired cutting force.

10. In a system for controlling the movement of a robot using a controller having tunable gains for proportional and integral control a method for obtaining a controlled removal rate of material from a workpiece when a tool engages said workpiece, either said tool movable and said workpiece stationary or said workpiece movable and said tool stationary, said method comprising:
adding a loop to said controller to tune said proportional control and said integral control tunable gains in response to a command for the feed rate of either said movable tool or said movable workpiece when said tool engages said workpiece and a cutting force to be applied to said workpiece when said tool engages said workpiece to provide a command to control said cutting force to be applied to said workpiece when said tool engages said workpiece to be substantially the same as a desired cutting force.

11. A system for a controlled removal rate of material from a workpiece by a tool in a robotic machining process, either said tool movable and said workpiece stationary or said workpiece movable and said tool stationary, comprising:
a robot; and
a controller having tunable gains for both proportional and integral control, said controller responsive to a command for the feed rate of said movable tool or said movable when said tool engages said workpiece and a cutting force to be applied to said workpiece when said tool engages said workpiece for tuning said proportional control and said integral control tunable gains to provide a command to control said robot so that said cutting force to be applied to said workpiece when said tool engages said workpiece to be substantially the same as a desired cutting force.

12. The system of claim 11 wherein said robot holds said tool and said workpiece is stationary and said robot in response to said cutting force control command moves said tool along a predetermined path when said tool engages said workpiece.

13. The system of claim 11 wherein said robot holds said workpiece and said tool is stationary and said robot in response to said cutting force control command moves said workpiece along a predetermined path when said tool engages said workpiece.

14. A method for regulating within a predetermined range the force an object held by a robot applies to a stationary object when said held object is brought into contact with said stationary object comprising:
obtaining a signal indicative of said force applied by said held object to said stationary object; and
using said force applied indicative signal to control the rate at which said robot moves said held object in relation to said stationary object when said held object is brought into contact with said stationary object.

15. A computer program product for regulating within a predetermined range the force an object held by a robot applies to a stationary object when said held object is brought into contact with said stationary object comprising:
a computer-readable medium having instructions for causing a computer to execute a method comprising:
obtaining a signal indicative of said force applied by said held object to said stationary object; and
using said force applied indicative signal to control the rate at which said robot moves said held object in relation to said stationary object when said held object is brought into contact with said stationary object.

16. A system for regulating within a predetermined range the force an object held by a robot applies to a stationary object when said held object is brought into contact with said stationary object comprising:
a computing device having therein program code usable by said computing device, said program code comprising:
code configured to obtain a signal indicative of said force applied by said held object to said stationary object; and
code configured to use said force applied indicative signal to control the rate at which said robot moves said held object in relation to said stationary object when said held object is brought into contact with said stationary object.
